(19) United States
(12) Patent Application Publication
(10) Pub. No.: US 2006/0151617 A1
(43) Pub. Date: Jul. 13, 2006

(54) Memory unit with data transmit and receive capability

(76) Inventor: Yukio Masubuchi, Saitama-shi (JP)

Correspondence Address: GAUTHIER & CONNORS, LLP, 225 FRANKLIN STREET, BOSTON, MA, 02110, US

(21) Appl. No.: 11/226,841

(22) Filed: Sep. 14, 2005

(30) Foreign Application Priority Data
Jan. 7, 2005 (JP) 2005-003113

(51) Int. Cl. G06K 19/06

(52) U.S. Cl. 235/492

(57) ABSTRACT

The present invention provides a memory unit having the capability of transmitting and receiving data to and from an external device. The memory unit includes a first memory configured such that data can be written to and erased from the first memory, a second memory, and a data transfer device that transfers at least a portion of the data held in the second memory to the first memory.

### BACKGROUND OF THE INVENTION

1. Field of the Invention

The present invention relates to a technique for a contact type or non-contact type IC (integrated circuit) that transmits and receives data to and from an external device in a contact manner or in a non-contact manner, or a wired memory unit or a wireless memory unit for use in such an IC. More specifically, the present invention relates to a technique for managing data stored in these devices.

2. Description of the Related Art

In general, contact type ICs in which power for causing an IC to operate is supplied from a power supply unit through a wire and a data line for exchanging data is also connected to other devices through a wire are widely used.

Non-contact Ics, on the other hand, are compact devices in which each device has an antenna and an integrated circuit (IC) to transmit and receive data to and from an external device based on electromagnetic principles, and are beginning to be used in various fields, such as an IC incorporated in a card for use in payment or identification, or an IC attached to merchandise for use in management of production or distribution.

For example, in an image forming apparatus such as a printer or a copying machine, a contact type IC or a non-contact IC may be attached to a consumable item such as a toner cartridge or a photoreceptor cartridge. When this is done, in the case of a contact type IC, by supplying power and communicating data through a contact connector, it is possible for the image forming apparatus to obtain and use data stored in the contact type IC, while, in the case of a non-contact type IC, by communicating with the non-contact IC through a reader/writer provided within the image forming apparatus, it is possible to obtain and use data stored in the non-contact IC.

As an example of a situation in which a contact type IC or a non-contact IC is used in such an image forming apparatus, there is an embodiment wherein, in order to reliably deliver consumable items to customers through sales routes, customer information regarding purchasing customers is written to a contact type IC or a non-contact IC at the time of shipment. However, in cases where there are a large number of consumable items, a consumable item may be mistaken for another or may be lost during distribution, at the customer's premises, in the process of recycling, or somewhere else, and it is possible that the customer information cannot be managed appropriately.

Further, as an example of a non-contact IC, a technique for a non-contact IC is disclosed such that a password or other personal information is written in a RAM connected to a power storage device such as a capacitor, and that information disappears at a point in time at which the power storage device has been discharged completely.

In this technique, however, it is impossible to reliably erase customer information. This is because the discharge time of a power storage device typically varies depending on manufacturing variations in a capacitor or other components, and depending on a use environment such as an ambient temperature, and the point in time at which data stored in a RAM disappears is uncertain. Further, this technique is intended to only erase data in a relatively short period of time, and is based on the assumption that information is initially written by a customer side. Therefore, it is difficult to deal with a situation in which data should be maintained over a relatively long period of time such as from the time of shipment of a consumable item until the customer uses the item.

### SUMMARY OF THE INVENTION

According to one aspect of the present invention, there is provided a memory unit that includes a first memory configured such that data can be written to and erased from the first memory, a second memory, and a data transfer device that transfers at least a portion of data held in the second memory to the first memory.

Further, according to another aspect of the present invention, there is provided a method that can be performed in a non-contact IC having a transmitting and receiving device that transmits and receives data to and from an external device in a non-contact manner; a first memory configured such that data can be written to and erased from the first memory; a second memory that is capable of holding data for a longer period of time than the first memory, and configured such that data can at least be erased from the second memory; and a timer device that measures an elapsed time. This method includes the steps of transferring at least a portion of data held in the second memory to the first memory, and erasing, from the first memory, at least a portion of the data transferred in the data transfer step when a set period of time has elapsed after the data transfer step is performed based on a measurement performed by the timer device.

### BRIEF DESCRIPTION OF THE DRAWINGS

Embodiments of the present invention will be described in detail based on the following figures, wherein:

FIG. 1 is a schematic diagram showing the structure of a non-contact IC according to an embodiment of the present invention;

FIG. 2 is a schematic diagram showing an example structure of an RTC of the non-contact IC as shown in FIG. 1;

FIG. 3 is a flowchart showing operation of the non-contact IC as shown in FIG. 1;

FIG. 4 is a schematic diagram showing the structure of a non-contact IC according to a modified example;

FIG. 5 is a schematic diagram showing a device structure of a non-contact IC according to another modified example;

FIG. 6 is a schematic diagram showing an example device structure of an RTC of the non-contact IC as shown in FIG. 5;

FIG. 7 shows an example structure of a memory unit that can be used in a contact IC or a non-contact IC;

FIG. 8 shows another example structure of the memory unit; and

FIG. 9 shows still another example structure of the memory unit.

### DETAILED DESCRIPTION OF THE INVENTION

Typical embodiments of the present invention will be described below. In the following description, a case in which a non-contact IC in use is attached to a toner cartridge to be inserted into a printer will be explained as an example.

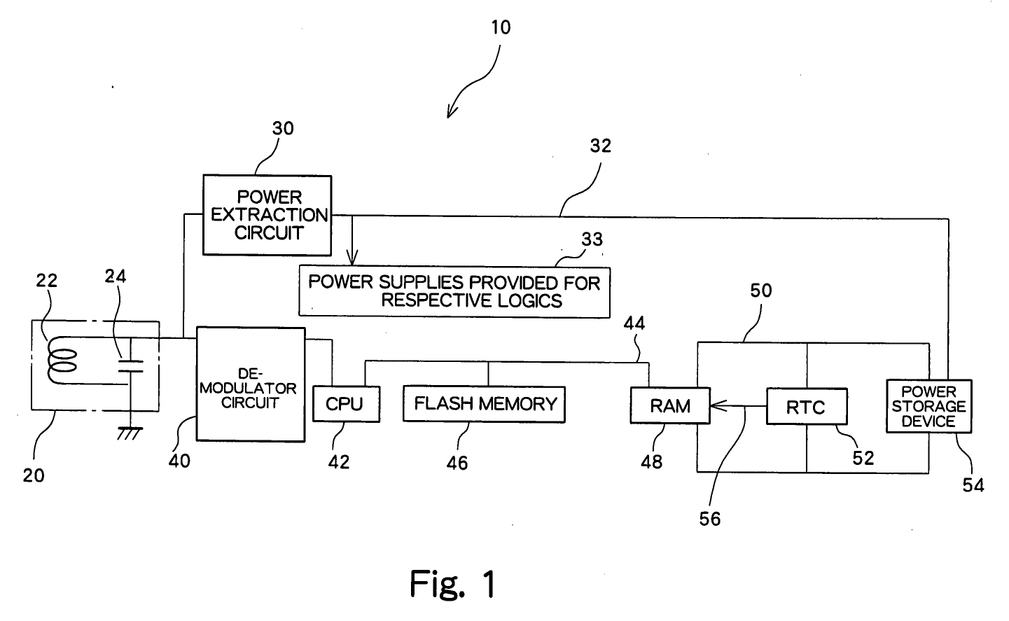

FIG. 1 is a schematic diagram showing the structure of a non-contact IC 10 according to an embodiment of the present invention. An antenna resonance circuit 20 is provided to communicate with a reader/writer mounted within a printer based on inductive coupling. The antenna resonance circuit 20 is provided with a coil antenna 22 and a tuning capacitor 24, and has a resonance frequency defined by these discrete components. A component of a signal received by the antenna resonance circuit 20 is input to a power extraction circuit 30. The power extraction circuit 30 is a device that extracts power for driving the non-contact IC, and a power supply voltage 32 thus extracted is supplied to power supplies 33 provided for respective logics. The antenna resonance circuit 20 is also connected to a demodulator circuit 40. The modulator circuit 40 is a circuit that extracts useful data from a received signal, and the extracted data is output to a CPU 42.

The CPU 42 is a device that controls communication to and from the non-contact IC 10, manages data stored in the non-contact IC 10, and performs other operations. For example, the CPU 42 analyzes a command transmitted from a reader/writer, and, in accordance with that command, performs reading/writing of data, responding to the reader/writer, or the like. The CPU 42 is connected to a memory local bus 44. The memory local bus 44 is a communication channel for connecting the CPU 42 to a flash memory 46 and a RAM 48. The flash memory 46 is a memory chip configured such that data can be written to and erased from the memory chip, and which does not lose data stored therein when the power supply is interrupted. In contrast, the RAM 48 is a memory chip configured such that data can be written to and erased from the memory chip, but which loses data stored therein when power supply is stopped. In other words, the flash memory 46 functions as a long-term memory, and the RAM 48 functions as a short-term memory. The writing and reading of data to and from the flash memory 46 and the RAM 48 are performed based on an instruction (a command) from the CPU 42.

The RAM 48 is connected to an energy supply line 50. The energy supply line 50 is a line that supplies power to the RAM 48 and an RTC (real-time clock) 52 from a power storage device 54. The RTC 52 serves as a timer device that counts time, and also functions as an eraser device that transmits a data erase signal 56 to the RAM 48 to erase data stored in the RAM 48 when a set period of time has elapsed. The power storage device 54, which is provided with a capacitor, stores electrical energy in response to the power supply voltage 32 extracted by the power extraction circuit 30, and supplies power to the RAM 48 and the RTC 52.

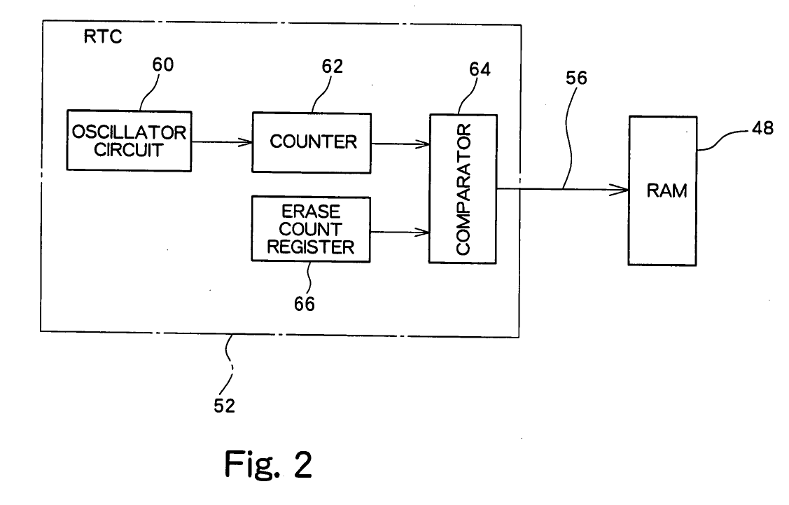

Referring next to FIG. 2, an example structure of the RTC 52 as shown in FIG. 1 will be described below. The RTC 52 includes an oscillator circuit 60, a counter 62, a comparator 64, and an erase count register 66. The oscillator circuit 60 is a circuit that oscillates at a predetermined oscillation frequency, and an output therefrom is supplied to the counter 62. The counter 62 is a device that counts the number of oscillations produced by the oscillator circuit 60. A value that represents an erase time for the RAM 48 in the form of the number of counts obtained by the counter 62 is set in the erase count register 66. When an output from the counter 62 becomes equal to an output from the erase count register 66, the comparator 64 outputs the data erase signal 56 to the RAM 48. By employing such a structure, when the counter 62 starts counting with a period of time until erasure being set in the erase count resister 66, it is possible to erase data stored in the RAM 48 after a desired period of time.

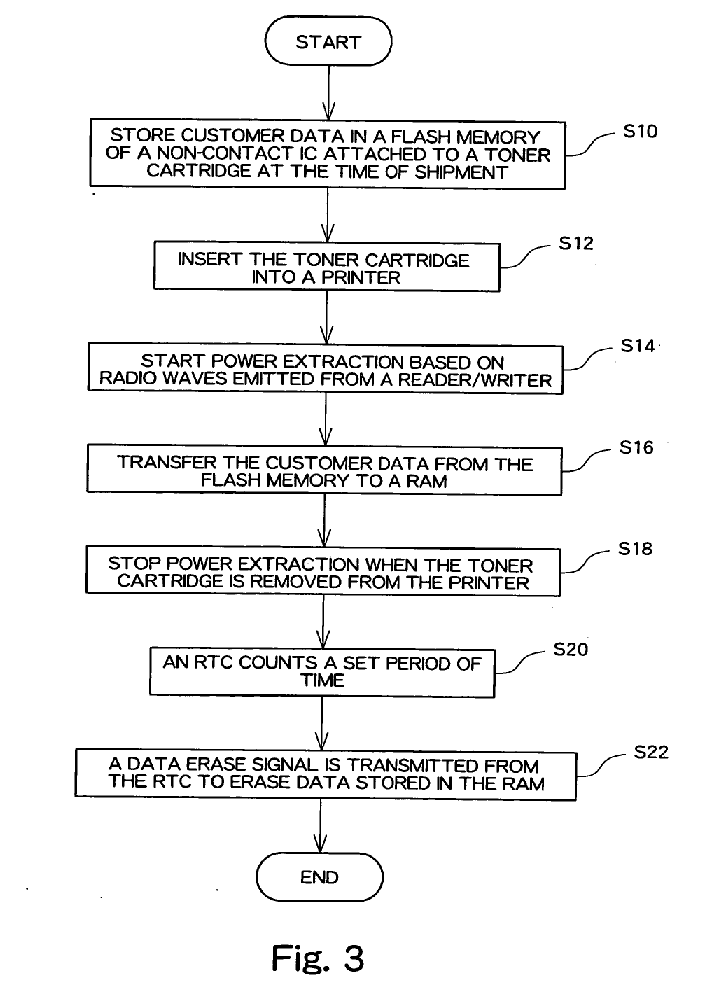

Referring next to the flowchart of FIG. 3, operation of the non-contact IC 10 will be described in connection with use of a toner cartridge. At the time of shipment of a toner cartridge, the model number and customer data regarding the customer to whom the toner cartridge should be delivered are input to the non-contact IC 10. This customer data is stored in the flash memory 46 in accordance with an instruction from the CPU 42 (S10). In the process of distribution, the customer data is read as needed, and the toner cartridge is delivered to the customer.

The delivered toner cartridge is unsealed by the customer, and is inserted into a printer (S12). In response to insertion of the toner cartridge, the printer causes the reader/writer to operate, and starts communication with the non-contact IC 10. In the non-contact IC 10, the power extraction circuit 30 starts to extract power (S14). The power thus extracted is used to cause the respective circuits to start operation. Then, at the side of the printer, the model number and customer data are read to perform image processing adjustment and other setting processing. On the other hand, at the side of the non-contact IC 10, when a start of continuous power extraction is detected (power extraction continues for a period of, for example, 5 seconds or more, which is longer than a period during which reading is performed in the process of distribution), the customer data stored in the flash memory 46 is transferred to the RAM 48 in accordance with a preinstalled program (S16).

After the toner is exhausted, the toner cartridge is removed from the printer. Thus, the communication with the reader/writer is terminated, and the power extraction by the power extraction circuit 30 is stopped (S18). In the non-contact IC 10, when a stop of the power extraction that has been continuous is detected, the RTC 52 starts counting down the set period of time (S20). When the set period of time is reached, the RTC 52 transmits a data erase signal 56 to the RAM 48, and the customer data transferred to the RAM 48 is erased (S22).

According to this embodiment, the customer data is stably stored in the flash memory 46 until the toner cartridge is inserted into a printer. In response to insertion of the toner cartridge into the printer, the data is transferred to the RAM 48. Therefore, because the customer data is reliably erased when the set period of time has elapsed after the toner cartridge is removed, it is possible to maintain confidentiality of the customer data.

Next, an example modification of the above-described embodiment will be described below.

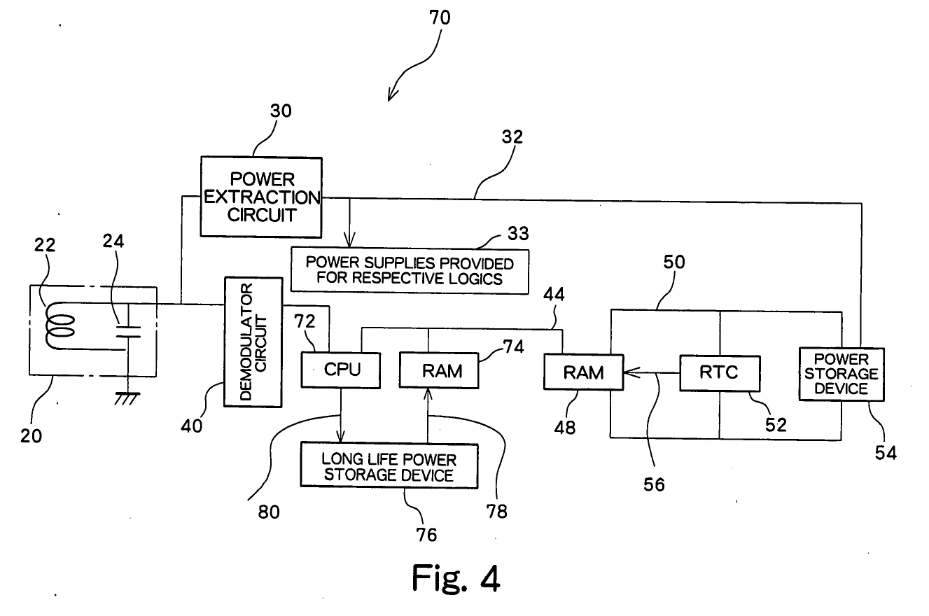

FIG. 4 is a schematic diagram showing a device structure of a non-contact IC 70 according to this modified example. Referring to FIG. 4, components similar to those of the non-contact IC 10 shown in FIG. 1 are denoted by the same reference numerals, and explanations thereof are not repeated here. Instead of the CPU 42 and the flash memory 46 provided in the non-contact IC 10, the non-contact IC 70 is provided with a CPU 72, a RAM 74, and a long life power storage device 76.

The long life power storage device 76 outputs, as a power source for the RAM 74, a supply of power 78 to the RAM 74. This long life power storage device 76 sets a period of time until discharge to be longer than that of the power storage device 54, and is formed using, for example, a capacitor with a capacity larger than that of the power storage device 54. The CPU 72 is capable of transmitting a discharge instruction signal 80 to the long life power storage device 76. When the long life power storage device 76 receives a discharge instruction signal 80, the long life power storage device 76 discharges electrical energy stored therein, and stops the power supply to the RAM 74. Thus, data stored in the RAM 74 disappears. The discharge instruction signal 80 transmitted by the CPU 72 may be issued based on an instruction wirelessly provided from an external source, or may be set to be issued when a certain period of time has elapsed, or when a certain trigger signal is detected.

If the structure of this example modification is used it is possible, for example, to erase data including customer data stored in the RAM 74 when a predetermined period of time has elapsed from the time of shipment of the toner cartridge. It is to be noted that, when it is desired to retain data which is not confidential, such as model number information, it is possible to retain such data by, for example, storing the data in a separately provided non-volatile memory, such as a flash memory.

Next, another example modification of the above-described embodiment will be described below.

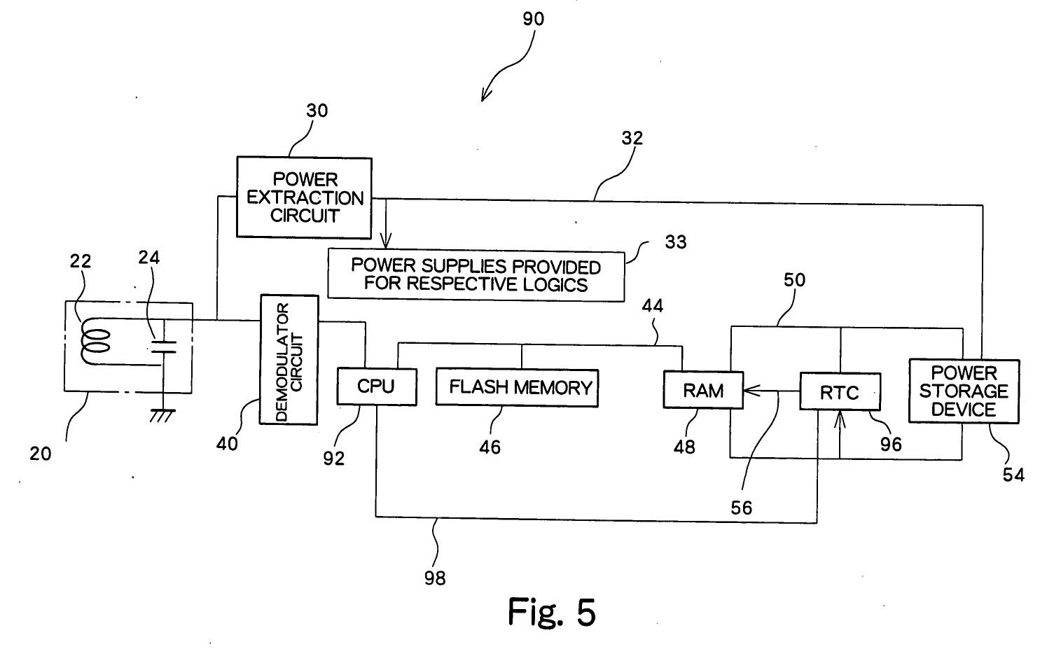

FIG. 5 is a schematic diagram showing a device structure of a non-contact IC 90 according to this modified example. Referring to FIG. 5, components similar to those of the non-contact IC 10 shown in FIG. 1 are denoted by the same reference numerals, and explanations thereof are not repeated here. Instead of the CPU 42 and the RTC 52 provided in the non-contact IC 10, the non-contact IC 90 is provided with a CPU 92 and an RTC 96. A count stop register write signal 98 is transmitted from the CPU 92 to the RTC 96.

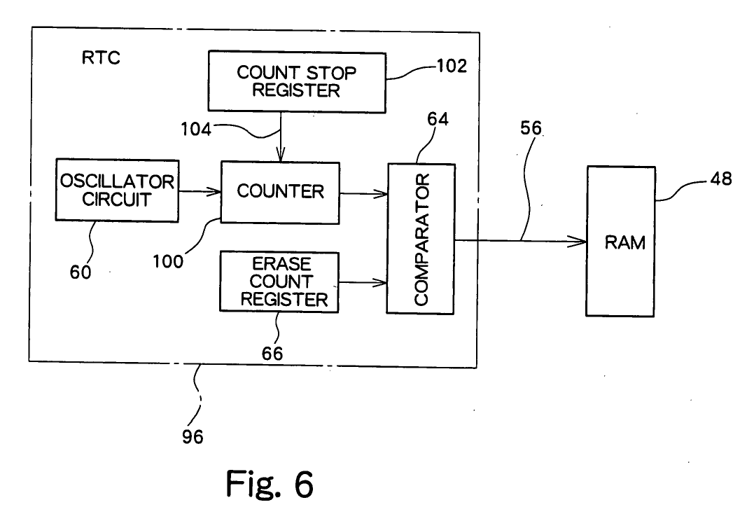

FIG. 6 is a diagram illustrating a structure of the RTC 96 included in the non-contact IC 90 as shown in FIG. 5. Referring to FIG. 6, components similar to those of the RTC 52 shown in FIG. 2 are denoted by the same reference numerals, and explanations thereof are not repeated here. Instead of the counter 62, this structure is provided with a counter 100, and this counter 100 includes the capability of stopping counting in response to input of a count enable signal 104 from a count stop register 102.

Next, operation of the non-contact IC 90 will be described below. The non-contact IC 90 operates basically in a similar manner to the non-contact IC 10 as described in FIGS. 1-3. However, it is possible to transmit a count stop register write signal 98 from the CPU 92 to the RTC 96 to stop counting down for erasing data from the RAM 48. The stop may be such that the count until then is cleared, or may be such that the count until then is maintained and the next count starts from that count.

When the structure of this modified example is employed, it is possible, for example, to maintain customer data when the toner cartridge is temporarily removed from the printer and is again installed in the printer. For example, the count stop register write signal 98 may be set to be issued when the printer detects that the toner cartridge has been re-installed and transmits a command signal to the non-contact IC 90 through the reader/writer, or, by programming the CPU 92, the count stop register write signal 98 may be set to be issued automatically when it is detected that the toner cartridge is again installed.

To enable handling of cases where the toner cartridge is removed for a long period of time, it is also effective to transfer the data transferred to the RAM 48 back to the flash memory 46.

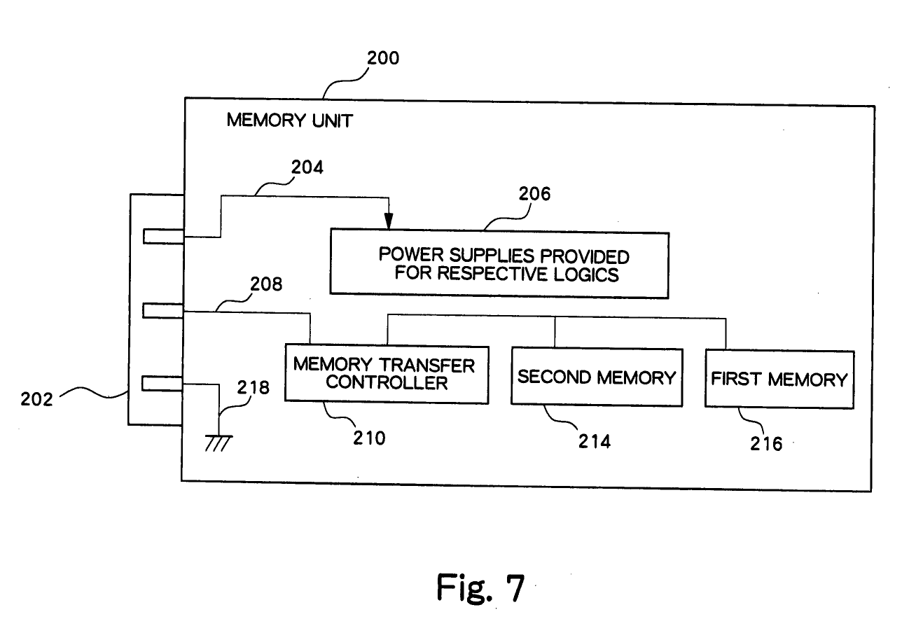

The main part of the non-contact IC as described above (such as the non-contact IC 10 shown in FIG. 1, the non-contact IC 70 shown in FIG. 4, and the non-contact IC 90 shown in FIG. 5) can be formed in the form of a memory unit, that is, a circuit device formed using a memory. Further, this memory unit can be used in a non-contact IC, and can also be utilized as a contact IC. In the following, example structures of the memory unit will be described with reference to FIGS. 7-9.

A memory unit 200 shown in FIG. 7 includes an IC formed on a substrate and an external connector 202 having three terminals formed on an edge of the substrate. One of these terminals is connected to a power supply line 204, which is further connected to power supplies 206 provided for respective logics. Another one of these terminals is connected to a memory data signal line 208, which is further connected to a memory transfer controller 210. A memory local bus 212 extends from this memory transfer controller 210, and is connected to two data memories, that is, a first memory 216 and a second memory 214. Further, a line 218 for grounding extends from the remaining terminal.

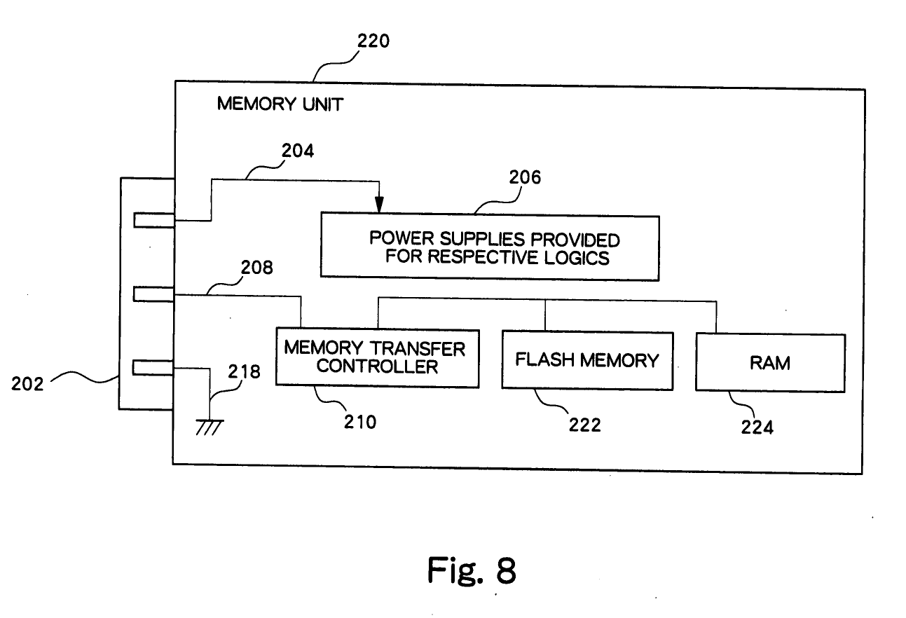

FIG. 8 shows a memory unit 220 as a modified embodiment of the memory unit 200 shown in FIG. 7. Referring to FIG. 8, identical components are denoted by the same reference numerals, and explanations thereof are not repeated here. In this memory unit 220, a RAM 224 serving as a short-term memory and a flash memory 222 serving as a long-term memory are respectively employed in place of the first memory 216 and the second memory 214 of the memory unit 200.

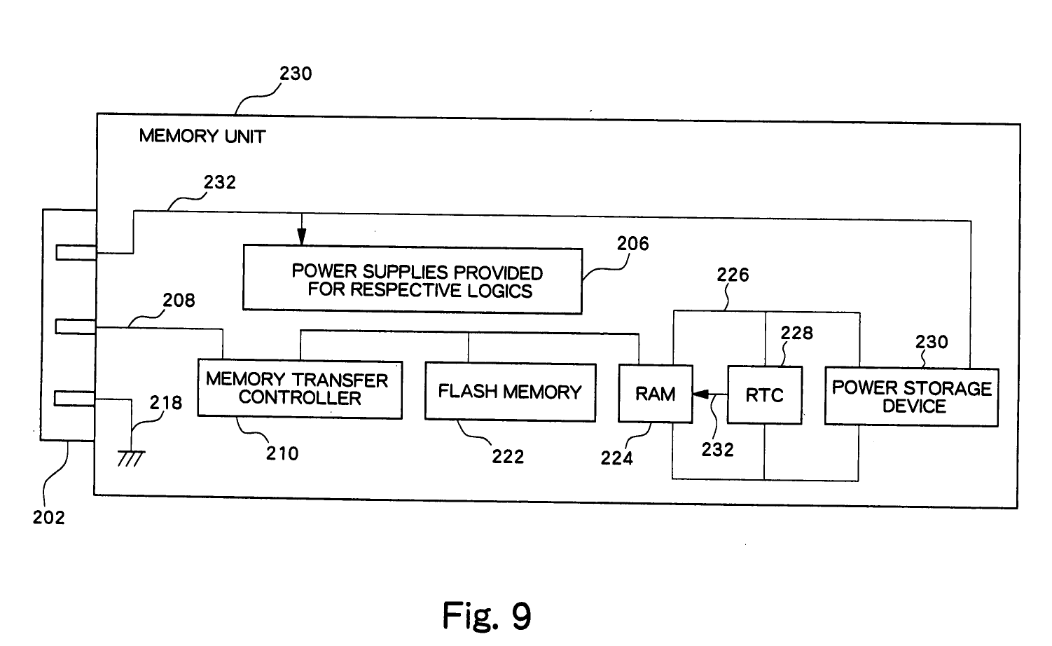

Further, a memory unit 230 shown in FIG. 9 represents a modified embodiment of the memory unit 220 shown in FIG. 8. Referring to FIG. 9, identical components are denoted by the same reference numerals, and explanations thereof are not repeated here. In this memory unit 230, an energy supply line 226 extends from the RAM 224, and is connected to an RTC 228 and a power storage device 229. The memory unit 230 is further configured such that a data erase signal can be transmitted from the RTC 228 to the RAM 224. In addition, power is supplied to the power storage device 229 through a power supply line 232.

It is possible for the memory units to be used as contact ICs through a wired connection by simply fitting the external connector thereof to an appropriate external circuit. On the other hand, in cases where these memory units are to be used as non-contact ICs, it is possible by simply using the external connector thereof in combination with an antenna resonance circuit, a power extraction circuit, a demodulator circuit, and the like. For example, when the memory unit 230 shown in FIG. 9 is formed as a non-contact IC, it is possible to form the non-contact IC 10 shown in FIG. 1.

Next, other various modifications of the above-described embodiments of the present invention will be described.

In one embodiment of the present invention, a non-contact IC of the present invention is a non-contact IC having capability of transmitting and receiving data to and from an external device in a non-contact manner. The non-contact IC includes a short-term memory configured such that data can be written to and erased from the short-term memory; a long-term memory that is capable of holding data for a longer period of time than the short-term memory, and configured such that data can at least be erased from the long-term memory; a data transfer device that transfers at least a portion of the data held in the long-term memory to the short-term memory; a timer device that measures an elapsed time; and an eraser device that erases at least a portion of the data transferred by the data transfer device after a set period of time has elapsed from a certain point in time based on the results obtained by a measurement performed by the timer device.

The non-contact IC is a compact device having an IC (integrated circuit) and an antenna, and is capable of transmitting and receiving data to and from an external device through the antenna. The short-term memory is a memory configured such that data can be newly written to the memory, and data can be erased from the memory. For example, a RAM (random access memory) can be used as such a memory. The long-term memory is a device that is capable of holding data for a longer period of time than the short-term memory, and from which data can at least be erased. For example, a memory that can hold data even when power supply is stopped (a non-volatile memory) such as a flash memory, a RAM that is driven by a power supply having a longer lifespan than that for the short-term memory, or the like can be used as such a device. The data transfer device is a device that transfers at least a portion of the data stored by the long-term memory to the short-term memory. The term “transfer” as used herein refers not only to the process of copying data to the short-term memory, but also to the process of erasing data from the long-term memory. The timer device is a device that measures an elapse of time through the use of a counter or the like. The eraser device erases, from the short-term memory, at least a portion of the data that is transferred by the data transfer device and is stored in the short-term memory. This erasure is carried out after a set period of time has elapsed from a certain point in time through the use of a measurement result of an elapsed time measured by the timer device. The set period of time may be determined by, for example, balancing the convenience offered by retaining data and the risk of leakage of confidential information caused by retaining data.

By employing the above-described structure, data to be erased can be erased at a preset time regardless of manufacturing variations in a power supply or a short-term memory, a use environment, or the like. In other words, it is possible to erase data reliably at a specific time without depending on the interruption of the supply of power supply from a power supply, which occurs at unpredictable points in time. In particular, when confidential data is set to be erased, it is possible to reliably prevent leakage of confidential information after a set period of time has elapsed. Further, with this structure, it is also possible to maintain data stored in the long-term memory for a long period of time when the data transfer device is not caused to operate.

According to another aspect of the present invention, there is provided a non-contact IC further including a first power supply that is charged based on power obtained in a non-contact manner, and which stops power supply to the short-term memory in response to exhaustion of the charged power, wherein the short-term memory stores data based on power supplied from the first power supply, and loses data when power supply is stopped. The first power supply includes a power storage device, such as a capacitor or the like, which is charged by receiving a supply of power obtained based on waves received from an external device, and thereby serves as a power supply source for at least the short-term memory. When the charged power is exhausted (discharged), power supply to the short-term memory stops. The short-term memory is a device, such as, for example, a RAM, which functions in response to a supply of power from the first power supply, and which loses data when power supply is stopped. In this structure, the period of time set for the eraser device may be longer or shorter than a period of time over which power can be supplied from the first power supply. When the set period of time is shorter, that period represents a period of time until data is erased, and, when the set period of time is longer, that period ensures a point in time by which it can be assured that data will be reliably erased.

According to another aspect of the present invention, there is provided a non-contact IC, wherein data transfer by the data transfer device is performed when power is supplied continuously in a non-contact manner. As a result, it is possible to transfer confidential information to the short-term memory in response to the non-contact IC or an article including the non-contact IC being moved to an area where communication with a device at the other end is possible. It is to be noted that timing of data transfer by the data transfer device can also be set in various other manners. For example, by employing a structure such that data transfer is performed when transfer command data is received, it is also possible to control operation for maintaining confidentiality from the side of a reader/writer.

According to still another aspect of the present invention, there is provided a non-contact IC, wherein the point in time for the eraser device is a point at which the then-to-fore continuous supply of power supplied in a non-contact manner is interrupted. As a result, it is possible to start the countdown to erasure of confidential information in response to the non-contact IC or an article including the non-contact IC being moved out of an area in which communication with a device at the other end is possible. The data transfer by the data transfer device may be performed at a point in time when continuous supply of power is interrupted. It is to be noted that the certain point in time for the eraser device can also be set in various other manners. For example, by setting the point in time to a point at which an erasure command data is received, it is also possible to control operation for maintaining confidentiality from the side of a reader/writer.

According to still another aspect of the present invention, there is provided a non-contact IC further including a second power supply that supplies power to the long-term memory, wherein the second power supply is capable of supplying power for a longer period of time than the first power supply, wherein the long-term memory is a device that stores data based on power supplied from the second power supply, and which loses data when power supply is stopped, thereby enabling the long-term memory to hold data for a longer period of time than the short-term memory. By employing this structure, even when the trigger that causes data to be transferred to the short-term memory does not function, it is possible to erase confidential information or other data stored in the long-term memory after an appropriate period of time has elapsed.

According to still another aspect of the present invention, there is provided a non-contact IC further including a second eraser device that erases at least a portion of the data stored in the long-term memory after a second set period of time has elapsed beyond a certain point in time as measured by the timer device. By employing this structure, it is possible to reliably erase data that is stored in the long-term memory after the second set period of time has elapsed.

According to still another aspect of the present invention, there is provided a non-contact IC further including an erasure stopping device that stops operation of the timer device or the eraser device so that the eraser device does not perform data erasure. The erasure stopping device fulfills the demand that it be possible to hold data for some reason after the timer device starts counting of an elapsed time. The erasure stopping device can be set to operate in response to, for example, transmission of an operation instruction command from a reader/writer to the non-contact IC. In this structure, from the viewpoint of confidentiality, it is particularly desirable to transmit the operation instruction command in encrypted form. When operation of the timer device is to be stopped, the counting may be temporarily suspended, or the counting itself may be permanently discontinued. Further, it is to be noted that the second eraser device may be provided with a second erasure stopping device similar to the above-described erasure stopping device.

According to still another aspect of the present invention, there is provided a non-contact IC further including a data copying device that copies, to the long-term memory, at least a portion of the data transferred to the short-term memory by the data transfer device. The data copying device is effective in situations in which it is desired that data which has been transferred to the short-term memory again be held for a longer period of time. When data is to be copied to the long-term memory, the original data to be copied may be erased from the short-term memory, or does not have to be erased. The data copying device can be set to operate in response to, for example, transmission of an operation instruction command from a reader/writer to the non-contact IC. With this structure, from the viewpoint of confidentiality, it is particularly desirable to transmit the operation instruction command in encrypted form.

According to still another aspect of the present invention, there is provided a method performed by a non-contact IC including a transmitting and receiving device that transmits and receives data to and from an external device in a non-contact manner; a short-term memory configured such that data can be written to and erased from the short-term memory; a long-term memory that is capable of holding data for a longer period of time than the short-term memory, and configured such that data can at least be erased from the long-term memory; and a timer device that measures an elapsed time, the method including the steps of transferring at least a portion of the data held in the long-term memory to the short-term memory; and erasing, from the short-term memory, at least a portion of the data transferred in the data transfer step when a set period of time has elapsed after the data transfer step is performed based on a result measured by the timer device.

It is to be understood that the present invention is not limited to the details of the above-described embodiments, but may be modified in various manners without departing from the scope and spirit of the present invention.

The disclosure of Japanese Patent Application No. 2005-3113 filed on Jan. 7, 2005 including the specification, claims, drawings and abstract is incorporated herein by reference in its entirety.

What is claimed is:

1. A memory unit having capability of transmitting and receiving data to and from an external device, the memory unit comprising:
a first memory configured such that data can be written to and erased from the first memory;
a second memory; and
a data transfer device that transfers at least a portion of data held in the second memory to the first memory.

2. A memory unit according to claim 1, wherein the second memory is capable of holding data for a longer period of time than the first memory.

3. A memory unit according to claim 1, further comprising an eraser device that erases, from the first memory, at least a portion of the data transferred by the data transfer device.

4. A memory unit according to claim 2, further comprising an eraser device that erases, from the first memory, at least a portion of the data transferred by the data transfer device.

5. A memory unit according to claim 3, further comprising a trigger setting device that sets a trigger to cause the eraser device to operate.

6. A memory unit according to claim 5, further comprising a timer device that measures an elapsed time, wherein
the trigger setting device sets a trigger based on a measurement performed by the timer device, and
the eraser device erases at least a portion of the data transferred by the data transfer device after a set period of time has elapsed from a certain point in time.

7. A non-contact IC comprising a memory unit, wherein the capability of transmitting and receiving data to and from an external device is achieved in a non-contact manner, the memory unit comprising:
a first memory configured such that data can be written to and erased from the first memory;
a second memory;
a data transfer device that transfers at least a portion of data held in the second memory to the first memory.

8. A non-contact IC according to claim 7, wherein the second memory is capable of holding data for a longer period of time than the first memory.

9. A non-contact IC according to claim 7, wherein the memory unit further comprising an eraser device that erases, from the first memory, at least a portion of the data transferred by the data transfer device.

10. A non-contact IC according to claim 8,further comprising an eraser device that erases, from the first memory, at least a portion of the data transferred by the data transfer device.

11. A non-contact IC according to claim 9, further comprising a trigger setting device that sets a trigger to cause the eraser device to operate.

12. A non-contact IC according to claim 11, further comprising a timer device that measures an elapsed time, wherein the trigger setting device sets a trigger based on a measurement performed by the timer device, and the eraser device erases at least a portion of the data transferred by the data transfer device after a set period of time has elapsed from a certain point in time.

13. A non-contact IC according to claim 8, further comprising a first power supply that is charged based on power obtained in a non-contact manner, and which stops supplying the power to the first memory in case that the first power supply has exhausted the charged power, wherein
the first memory stores the data based on the power supplied from the first power supply, and loses the data in case that the first power supply stops supplying the power to the first memory.

14. A non-contact IC according to claim 7, wherein the data transfer device transfers the data when obtaining of power is continuously performed in a non-contact manner.

15. A non-contact IC according to claim 12, wherein the certain point in time for the eraser device is a point at which obtaining of power that has been continuously performed in a non-contact manner is stopped.

16. A non-contact IC according to claim 13, further comprising a second power supply that supplies power to the second memory, wherein the second power supply is capable of supplying the power for a longer period of time than the first power supply, wherein
the second memory is a device that stores the data based on the power supplied from the second power supply, and which loses the data when power supply is stopped, thereby enabling the second memory to hold the data for a longer period of time than the first memory.

17. A non-contact IC according to claim 12, further comprising a second eraser device that erases at least a portion of data stored in the second memory after a second set period of time has elapsed from a certain point in time based on a measurement performed by the timer device.

18. A non-contact IC according to claim 12, further comprising an erasure stopping device that stops operation of the timer device or the eraser device so that the eraser device is not caused to perform data erasure.

19. A non-contact IC according to claim 7, further comprising a data copying device that copies, to the second memory, at least a portion of the data transferred to the first memory by the data transfer device.

20. A method, performed by a non-contact IC comprising:
a transmitting and receiving device that transmits and receives data to and from an external device in a non-contact manner;
a first memory configured such that the data can be written to and erased from the first memory;
a second memory that is capable of holding the data for a longer period of time than the first memory, and configured such that data can at least be erased from the second memory; and
a timer device that measures an elapsed time, the method comprising the steps of:
transferring at least a portion of the data held in the second memory to the first memory; and
erasing at least a portion of the data transferred in the data transfer step from the first memory when a set period of time has elapsed after the data transfer step is performed based on a measurement performed by the timer device.

21. A non-contact IC according to claim 13, wherein the data transfer device transfers the data when the first power supply obtains the power continuously in a non-contact manner.

22. A non-contact IC according to claim 12, further comprising a first power supply that is charged based on power obtained in a non-contact manner, and which stops supplying the power to the first memory in case that the first power supply has exhausted the charged power, wherein the first memory stores the data based on the power supplied from the first power supply, and loses the data in case that the first power supply stops supplying the power to the first memory, and the certain point in timer for the eraser device is a point that the first power supply stoops obtaining the power in a non-contact manner.
